(19) United States
(12) Patent Application Publication
(10) Pub. No.: US 2020/0086524 A1
(43) Pub. Date: Mar. 19, 2020

(54) BAND SAW BLADE GUARD ASSEMBLY

(71) Applicants: Jeffrey Earl Daniel, Johnston, IA (US); Terrence L. Garnes, Coon Rapids, IA (US)

(72) Inventors: Jeffrey Earl Daniel, Johnston, IA (US); Terrence L. Garnes, Coon Rapids, IA (US)

(21) Appl. No.: 16/535,834

(22) Filed: Aug. 8, 2019

Related U.S. Application Data
(60) Provisional application No. 62/733,166, filed on Sep. 19, 2018.

(51) Int. Cl. B27G 19/06

(52) U.S. Cl. CPC B27G 19/06

(57) ABSTRACT

A blade guard assembly for use with a band saw has a blade guard housing integral to, or attached to, a band saw housing. Disposed within the blade guard housing is a spring. A guard member is slidably received within and extend out of the blade guard housing. The guard member is biased by the spring to engage a bumper attached to the blade saw housing in a normal position and retracts when an object is in the cutting zone.

### CROSS REFERENCE TO RELATED APPLICATION

This application claims the benefit of the priority of U.S. Provisional Ser. No. 62/733,166 filed on Sep. 19, 2018, the contents of these applications are hereby incorporated by reference in their entirety.

### BACKGROUND OF THE INVENTION

This invention is directed to a blade guard assembly for a band saw, and more particularly, a spring-loaded blade guard assembly.

Band saws are well-known in the art of having been introduced to the industry in the early 19^{th} century. Generally, band saws include a sharpened continuous band of toothed metal stretched between multiple wheels to cut material. A motor spins the wheels, which causes the stretched blade to move in sync with the wheels. More recently, portable and cordless band saws have become popular.

While useful, a problem with current band saws is that an operator is exposed to a band saw blade at all times. As a result, operators occasionally accidentally allow their hands, fingers, and other body parts to come in contact with the band saw blade during operation. This leads to unwanted lacerations, and, in some cases, amputation.

Safety switches and the like have been developed in response to this problem, but these devices do not prevent operator error, which can occur in a split second. Accordingly, a need exists in the art for a device that addresses these needs.

An objective of the present invention is to provide a blade guard assembly that reduces or eliminates user error.

Another objective of the present invention is to provide a blade guard assembly that reduces the chance of lacerations.

These and other objectives will be apparent to those having ordinary skill in the art based upon the following written description, drawings and claims.

### SUMMARY OF THE INVENTION

A blade guard assembly for use with a band saw includes a blade guard housing, a spring (or other biasing member intended to extend away from the guard housing 32 in the normal position), and a guard member slidably received within and extending out of the blade guard housing. The blade guard housing is associated with a housing of a band saw and is either integral to the band saw housing or attached to the band saw housing.

The spring or similar biasing member (intended to extend away from the guard housing 32 in normal position), is disposed within the blade guard housing and preferably is connected to an end wall of the blade guard housing. The guard member is attached to the opposite end of the spring. In a normal, non-operational position, the guard member is biased out of the blade guard housing, across and below a cutting zone of the blade of the band saw, to engage a bumper attached to the blade saw housing. An outer end of the guard member has an engagement member.

### BRIEF DESCRIPTION OF THE DRAWINGS

FIG. 1 is a side sectional view of a blade guard assembly;

FIG. 2 is a side view of a blade guard assembly;

FIG. 3 is an end view of a blade guard assembly;

FIG. 4 is a front side view of a blade guard assembly;

FIG. 5 is a partial rear side view of a blade guard assembly;

FIG. 6 is an end view of a blade guard assembly; and

FIG. 7 is a section end view of a blade guard assembly.

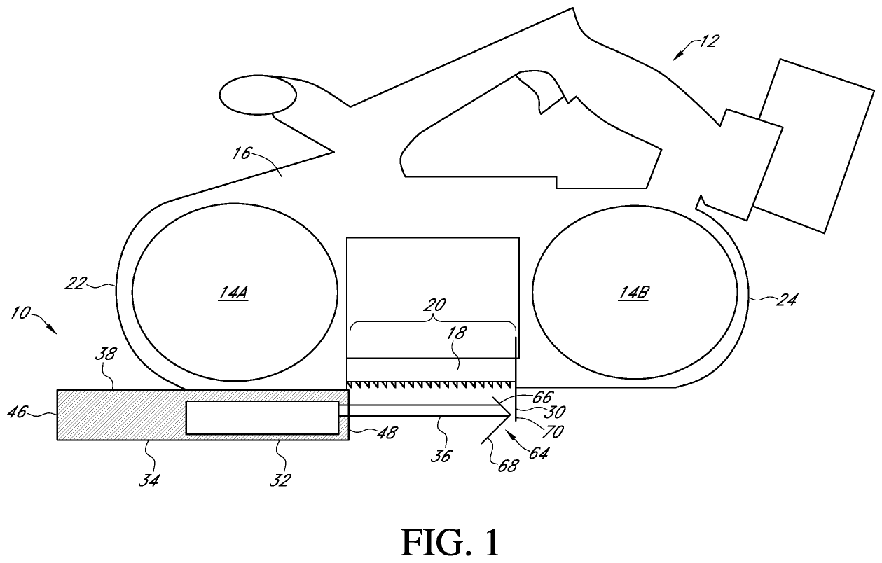

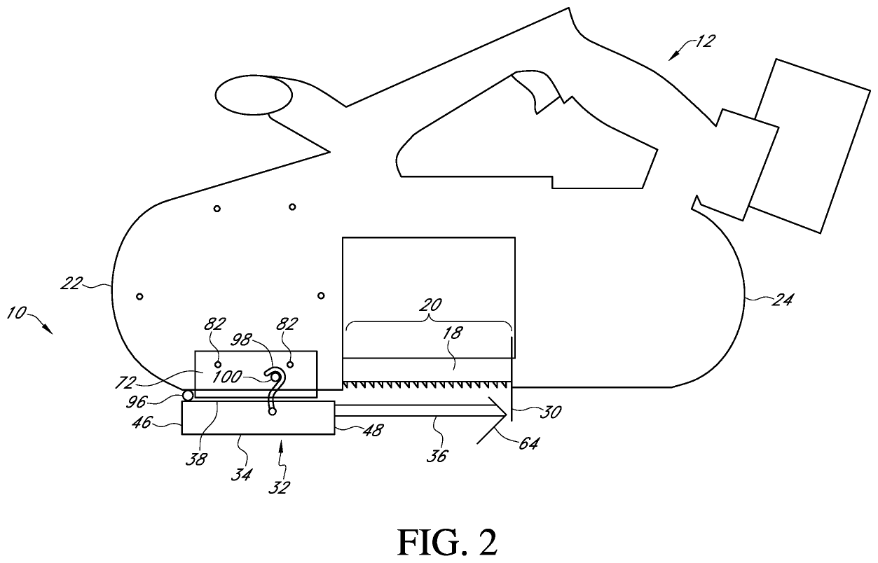

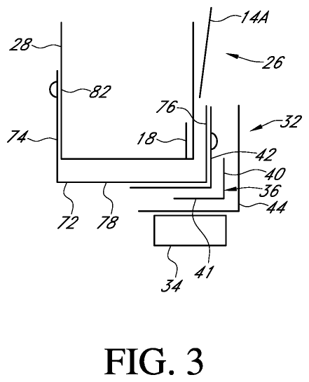

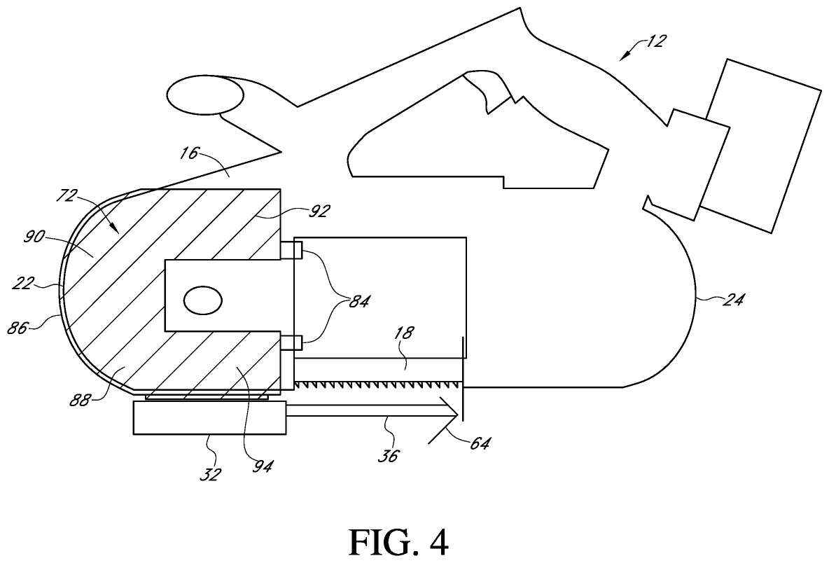

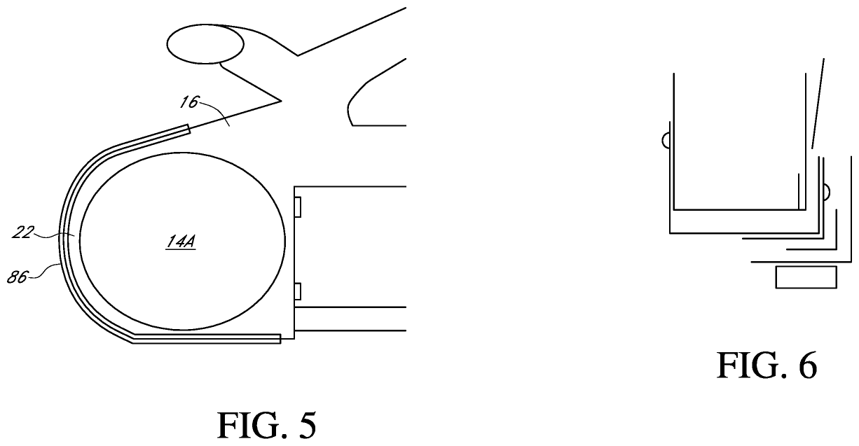

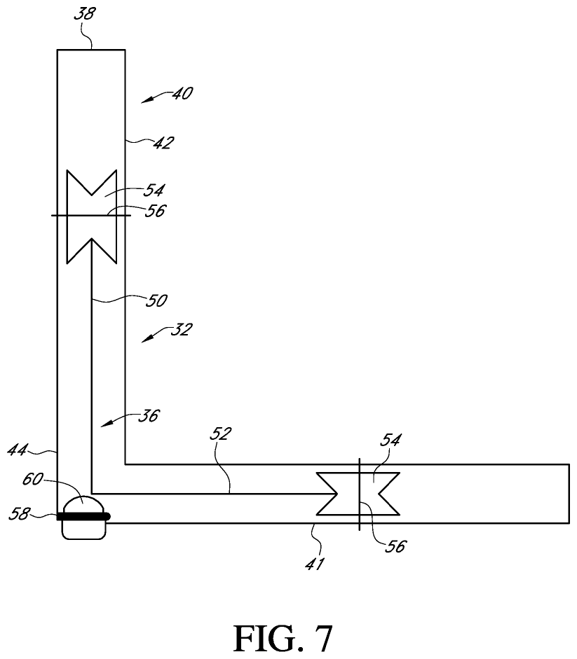

### DETAILED DESCRIPTION OF THE PREFERRED EMBODIMENT

Referring to the Figures, a band saw blade guard assembly 10 is used in relation to the conventional band saw 12, and preferably a portable or cordless band saw. Generally, a band saw 12 includes a pair of spaced apart wheels 14A and 14B, driven by a motor (not shown) and disposed within a housing 16. A continuous band of toothed metal or blade 18 is stretched between and moved by the wheels 14. The area between the wheels 14, where the blade 18 extends between, is a cutting zone or area 20.

The band saw housing 16 has a first end 22, a second end 24, a first or front side 26, and a second or rear side 28. Extending downwardly from the housing 16, adjacent wheel 14B at an edge of the cutting zone 20, is a bumper or stop 30.

The blade guard assembly 10 is of any size, shape, and structure and generally includes a guard housing 32, a spring or other biasing member 34 disposed within the guard housing 32, and a guard member 36 slidably received within and extending out of the guard housing 32. The guard member 36 is connected to an end of the spring 34 and is biased to extend away from the guard housing 32 in a normal position. Other examples of the blade guard assembly 10 include, but are not limited to cylindrical, square, rectangular, or other shape. The blade guard assembly 10 is made of metal, similar durable material, or any combination of the two.

The guard housing 32 is of any size, shape, and structure and generally includes a top wall 38, a first or inner wall 42, a second or outer wall 44, a first end wall 46, and a second open end 48. In one example the guard housing 32 is L-shaped having a vertical section 40 and a horizontal section 41. Other guard housing 32 examples include, but are not limited to, cylindrical, square, rectangular, or other shapes. The guard housing 32 is made of metal, similar durable material, or any combination of the two. The spring 34 is of any type and preferably is a constant force spring 34. Other means or an object can be used in place of a spring 34 to maintain a bias to extend away from the guard housing 32 in the normal position. In addition to being disposed within the guard housing 32, the spring 34 can also be attached to the outer wall 44 of the guard housing 32. Other examples of guard housing 32 shapes include, but are not limited to, cylindrical, square, rectangular, triangular, or other shapes.

The guard member 36 is of any size, shape and structure and is made of metal, similar durable material, or any combination of the two. In one example, the guard member 36 has a vertical portion 50 and a horizontal portion 52 disposed within the vertical section 40 and the horizontal section 41 of the guard housing 32 respectively. Attached to the top of the vertical portion 50 and the end of the horizontal portion 52 are grooved guide bearings 54 secured to the inner 42 and outer walls 44 within the guard housing 32 with a spacer 56. In the corner 58 of the outer wall 44 is a ball bearing 60. Alternatively, instead of grooved guide bearings 54 another type of bearing or a guide made of a material having low friction coefficient is used. Preferably, the tolerance, or distance, between the inner 42 and outer walls 44 and the guard member 36 are adapted to be small enough to prevent flex of the guard member 36 without interfering with the movement of the guard member 36 in and out of the guard housing 32. Other examples of guard member 36 and guard housing 32 shapes include, but are not limited to, cylindrical, square, rectangular, triangular, or other shapes.

Attached to, or integral with, an outer end 62 of the guard member 36 is an engagement member 64. The engagement member 64 is of any size, shape, and structure and preferably is interchangeable. In one example, the engagement member 64 has a first 66 and a second 68 angled portion. The first angled portion 66 extends from a tip 70 upwardly and backwardly toward the blade 18 and the guard housing 32. The second angled section 68 extends from the tip 70 downwardly and rearwardly away from the blade 18 and toward the guard housing 32. Alternatively, the engagement member 64 is of any size, shape and structure such as curved, arcuate, or the like. The engagement member 64 is made of a metal, similar durable material, or any combination of the two.

The guard housing 32 is either integrated into the band saw housing 16 or attached to the band saw housing 16 with a mounting member or bracket 72. In one example, the mounting bracket 72 is C-shaped having a first vertical section 74, a second vertical section 76, and a horizontal section 78 that connects the vertical sections 74 and 76. The first vertical section 74 has holes 80 positioned to align with existing screw holes 82 on the rear side 28 of the band saw housing 16. When attached with screws to the rear side 28, vertical section 74 engages the rear side 28 and extends below the band saw housing 16. The vertical section 74 terminates into the horizontal section 78 which extends below the band saw housing 16 in spaced parallel relation. The horizontal section 78 terminates into the second vertical section 76 which extends upwardly in spaced parallel relation to the front side 26 of the band saw housing and below wheel 14A. The inner wall 42 of the vertical sections 40 of the guard housing is bolted to the second vertical section 76 of the mounting bracket 72 and the inner wall 42 of the horizontal section 41 preferably engages horizontal section 78.

In another embodiment, the mounting bracket 72 wraps around the contour of the first end 22 of the band saw housing 16 and is attached to the housing 16 using clips 84. More specifically, the mounting bracket 72 has a first or outer arcuate end wall 86 that is adapted to receive and engage the arcuate first end 22 of the band saw housing 16. The arcuate end wall 86 terminates in a side wall 88 that extends across the front side 26 of the band saw housing 16 in parallel spaced relation. Preferably, the side wall 88 has a horseshoe or C-shape with an arcuate section 90 that terminates into a first or top horizontal section 92 and a second or bottom horizontal section 94. The clips 84 are attached and extended transversely to the ends of horizontal sections 92 and 94 and engage an inner wall 96 of the cutting zone 20 adjacent wheel 14A to secure the bracket 72 to housing 16. Preferably the guard housing 32 is secured to side wall 88 and extends underneath housing 16.

In yet another embodiment, the guard housing 32 is hingedly connected to the band saw housing 16 with a hinge 97 having any size, structure, or shape. The hinge 96, releasable locking member 98, and catch 100 are of any size, shape, or structure and are made of metal, similar durable material, or any combination of the two. A spring or other means may be integrated into the hinge design to return the guard to the normal position after a plunge cut. This allows for hands-free return of the guard housing to the normal operating position. Preferably, the hinge 96 is positioned on the top wall 38 of the guard housing 32 adjacent end wall 46. A releasable locking member 98, such as a hook or the like, connects to a catch 100 on housing 16 or mounting bracket 72 to maintain guard housing 32 in a horizontal position during operation. If the object to be cut remains in place and does not fall away after a plunge cut, the locking member 98 is removed from catch 100 and the guard 36 and guard housing 32 pivoted downwardly away from the band saw housing 16. This permits the band saw 12 to be removed from the object. While three embodiments of the mounting bracket 72 have been shown, the mounting bracket 72 is of any size, shape and structure. In operation, in a start or normal position, due to the force of the spring 34, the guard member is fully extended outwardly from the guard housing 32 through open end 48.

The engagement member 64 is in contact with the bumper 30. An object to be cut (not shown) is manually placed against the engagement member 64 and moved into the cutting zone 20. When moved into the cutting zone 20, the object causes the guard member 36 to slide back toward the guard housing 32 compressing the spring 34 permitting the guard member 36 to retract into the guard housing 32. During cutting, the engagement member 64 remains in spring-loaded contact with the object. Prior to cutting through the object completely, the guard member 36 returns to a normal position where the engagement member is in contact with the bumper 30. Thus, at all times, before, during, and after an object is cut, the guard member 36 is extended preventing an operator from contacting the blade 18.

What is claimed is:

1. A blade guard assembly for a band saw, comprising:
a blade guard housing associated with a housing of a band saw;
a spring disposed within the blade guard housing; and
a guard member connected to the spring and slidably received within and extending out of the blade guard housing.

2. The assembly of claim 1 wherein the guard member is connected to an end of the spring and is biased to extend away from the guard housing in a normal position.

3. The assembly of claim 1 wherein the blade guard housing has a first inner wall, a second outer wall, a first end wall, and a second open end.

4. The assembly of claim 3 wherein the guard housing has a vertical section and a horizontal section.

5. The assembly of claim 1 further comprising an engagement member attached to an end of the guard member.

6. The assembly of claim 1 wherein the blade guard housing is integrated with the band saw housing.

7. The assembly of claim 1 wherein the blade guard housing is attached to the band saw housing with a mounting member.

8. The assembly of claim 1 wherein the blade guard housing is hingedly connected to the band saw housing.

9. The assembly of claim 5 wherein the engagement member is adapted to engage a bumper attached to the band saw housing in a normal non-operational position.

10. The assembly of claim 5 wherein the guard member is adapted to slide back into the guard housing when an object is placed against the engagement member and moved into a cutting zone of a band saw.

11. The assembly of claim 10 wherein the guard member is adapted to return to a normal position where the engagement member contacts the bumper prior to cutting through the object completely.
